(19) United States
(12) Patent Application Publication
(10) Pub. No.: US 2025/0087707 A1
(43) Pub. Date: Mar. 13, 2025

(54) CURRENT COLLECTOR AND SECONDARY BATTERY

(71) Applicant: TOYOTA JIDOSHA KABUSHIKI KAISHA, Toyota-shi (JP)

(72) Inventor: Takuya MATSUYAMA, Toyota-shi (JP)

(73) Assignee: TOYOTA JIDOSHA KABUSHIKI KAISHA, Toyota-shi (JP)

(21) Appl. No.: 18/743,115

(22) Filed: Jun. 14, 2024

(30) Foreign Application Priority Data
Sep. 13, 2023 (JP) 2023-148254

(51) Int. Cl. H01M 4/66; H01M 4/02; H01M 4/134; H01M 4/38

(52) U.S. Cl. CPC H01M 4/668; H01M 4/134; H01M 4/386; H01M 4/661; H01M 4/667; H01M 2004/021; H01M 2004/027

(57) ABSTRACT

The current collector of the present disclosure includes a metal foil and a conductive resin layer laminated on the metal foil. The conductive resin layer in the current collector of the present disclosure includes a resin and a conductive material, and the resin has a melting point of less than 120° C. The secondary battery of the present disclosure includes a cathode current collector and a anode current collector, and at least one of the cathode current collector and the anode current collector is the current collector of the present disclosure.

### CROSS-REFERENCE TO RELATED APPLICATION

This application claims priority to Japanese Patent Application No. 2023-148254 filed on Sep. 13, 2023, incorporated herein by reference in its entirety.

### BACKGROUND

### 1. Technical Field

The present disclosure relates to a current collector and a secondary battery.

### 2. Description of Related Art

In recent years, a so-called resin current collector made of a resin to which a conductive filler such as a metal powder is added, instead of a metal foil, has been proposed.

For example, Japanese Unexamined Patent Application Publication No. 2010-170833 (JP 2010-170833 A) discloses a current collector having a structure including one or more layers, including resin and a conductive material. The current collector is a current collector for a bipolar secondary battery. In this current collector, a crystalline resin having a melting point of 120° C. or higher is used for at least one layer of resin.

### SUMMARY

Surface resistance of such a resin current collector is great, and accordingly it is thought that in a battery including the resin current collector, current flowing in a planar direction can be effectively suppressed at the time of internal short-circuiting, and as a result, local heat generation of the battery can be reduced. However, there is room for further improvement in suppressing heat generation at the time of internal short-circuiting of the battery.

An object of the present disclosure is to provide a current collector that is capable of suppressing heat generation at the time of internal short-circuiting of a battery.

The disclosers of the present disclosure found that the above issue can be solved by the following means.

### First Aspect

A current collector, comprising a metal foil, and
a conductive resin layer laminated on the metal foil.
The conductive resin layer includes a resin and a conductive material, and
a melting point of the resin is lower than 120° C.

### Second Aspect

In the current collector according to the first aspect,
a content of the resin in the conductive resin layer is no less than 50% by mass.

### Third Aspect

In the current collector according to the first aspect or the second aspect,
a thickness of the conductive resin layer is no less than 1 μm and no more than 10 μm.

### Fourth Aspect

A secondary battery includes
a cathode current collector and an anode current collector.
At least one of the cathode current collector and the anode current collector is the current collector according to any one of the first aspect to the third aspect.

### Fifth Aspect

The secondary battery according to the fourth aspect
further includes an anode active material layer.
The anode active material layer includes a silicon-based anode active material.

According to the present disclosure, a current collector capable of suppressing heat generation at the time of internal short-circuiting of a battery can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic cross-sectional view of an example of a current collector according to the present disclosure;

FIG. 1B is a schematic cross-sectional view of a current collector of the present disclosure showing how conductive foreign matter is trapped in a melted conductive resin layer due to heat generation associated with an internal short circuit;

FIG. 2 is a schematic cross-sectional view illustrating an exemplary secondary cell of the present disclosure; and

FIG. 3 is a graph showing the amount of heat generated during an internal short circuit in each example.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Current Collector

The current collector of the present disclosure includes a metal foil and a conductive resin layer laminated on the metal foil. The conductive resin layer in the current collector of the present disclosure includes a resin and a conductive material, and the resin has a melting point of less than 120° C.

The inventors of the present disclosure have found that in a battery including a current collector in which a conductive resin layer containing a resin having a low melting point is disposed on a metal foil, heat generation during an internal short circuit is suppressed. In a case where an internal short circuit of the battery occurs due to the inclusion of conductive foreign matters, it is conceivable that the resin melts at an early stage due to heat generation caused by the internal short circuit, thereby capturing the inclusion of conductive foreign matters so as to cover the inclusion. As a result, it is conceivable that the current flow is interrupted and a further increase in temperature is suppressed. In a battery including a current collector in which a conductive resin layer containing a resin having a low melting point is disposed on a metal foil, the reason why heat generation at the time of an internal short circuit is suppressed is considered to be that the current flow is interrupted and further increase in temperature is suppressed. However, this reason is not intended to be bound by any theory.

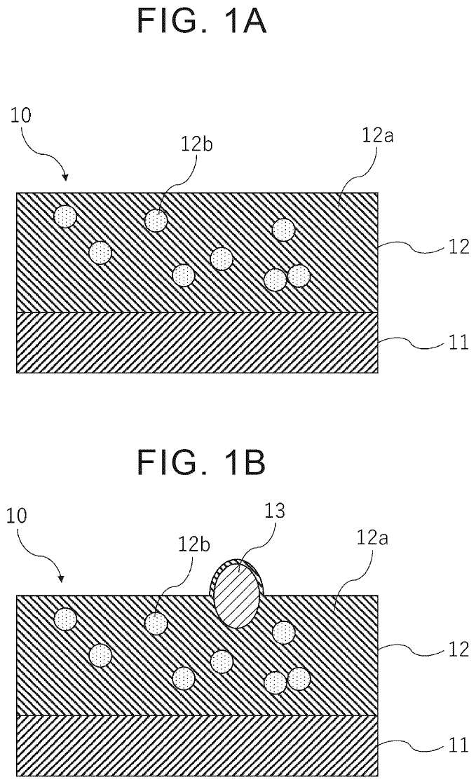

Hereinafter, the current collector of the present disclosure will be described with reference to FIGS. 1A and 1B. FIG. 1A is a schematic cross-sectional view of an example of a current collector according to the present disclosure. FIG. 1B is a schematic cross-sectional view of a current collector of the present disclosure showing how conductive foreign matter is trapped in the melted conductive resin layers due to heat generation associated with an internal short circuit. Note that dimensional relationships in FIGS. 1A and 1B, and other drawings do not reflect actual dimensional relationships.

As shown in FIG. 1A, the current collector 10 includes a metal foil 11 and a conductive resin layer 12 laminated on the metal foil 11.

### Metal Foil

The material used as the metal foil 11 is not particularly limited, and a material that can be used as a current collector of a battery can be appropriately adopted. Here, the “current collector” may be a cathode current collector or a anode current collector. The material of the metal foil that can be used for the cathode current collector may be, for example, SUS, nickel, chromium, gold, platinum, aluminum, iron, titanium, zinc, or the like, and a metal thereof plated or deposited with nickel, chromium, carbon, or the like. However, the material of the metal foil that can be used for the cathode current collector is not limited thereto. The material of the metal foil that can be used for the anode current collector may be, for example, copper, a copper alloy, and copper plated or deposited with nickel, chromium, carbon, and the like, but is not limited thereto.

### Conductive Resin Layer

The conductive resin layer 12 includes a resin 12a and a conductive material 12b.

### Resin

The melting point of the resin 12a is less than 120° C. The melting point may be 40° C. or higher, 45° C. or higher, 50° C. or higher, 55° C. or higher, or 60° C. or higher, and may be 110° C. or lower, 100° C. or lower, 95° C. or lower, 90° C. or lower, or 85° C. or lower.

If the melting point of the resin 12a is lower, the following may be considered when an internal short circuit occurs due to the inclusion of the conductive foreign matter 13. As shown in FIG. 1B, it is considered that the resin 12a melts early due to heat generation caused by the internal short circuit, and can be captured so as to cover the conductive foreign matter 13 mixed therein. As a result, it is considered that the current flow is interrupted, and further increase in temperature can be suppressed.

The content of the resin 12a in the conductive resin layer 12 may be 50% by mass or more. The content may be 60% by mass or more, 70% by mass or more, or 80% by mass or more, and may be less than 100% by mass, 95% by mass or less, or 90% by mass or less. When the content is within the above range, the fluidity when resin 12a melts due to heat generation becomes high, and the mixed conductive foreign matter 13 is easily caught.

The thickness of the conductive resin layer 12 may be 1 μm or more and 10 μm or less. The thickness may be 2 μm or more, 3 μm or more, 4 μm or more, 5 μm or more, and may be 9 μm or less, 8 μm or less, 7 μm or less, or 6 μm or less. When the thickness of the conductive resin layer 12 is within the above range, the mixed conductive foreign matter 13 is easily captured.

The resin 12a may be a resin, and specifically, the resin 12a may be an acrylic resin, polyvinyl chloride resin, methacrylic resin, polyethylene resin, polystyrene resin, or AS resin. The crystalline resin means a resin having a property of regularly arranging polymer chains at a temperature lower than or equal to the melting point.

### Conductive Material

The conductive material 12b is not particularly limited, and a material commonly used as a conductive auxiliary agent for batteries can be appropriately employed. For example, the conductive material 12b can be vapor grown carbon fiber (VGCF) and acetylene black (AB), Ketjen black (KB), carbon nanotubes (CNT), carbon nanofibers (CNF), and the like. However, the conductive material 12b is not limited thereto.

The content of the conductive material 12b in the conductive resin layer 12 may be greater than 0% by mass, greater than or equal to 5% by mass, or greater than or equal to 10% by mass, and may be less than or equal to 50% by mass, less than or equal to 40% by mass, less than or equal to 30% by mass, or less than or equal to 20% by mass.

### Other Ingredients

The conductive resin layer may optionally contain components other than the resin and the conductive material. For example, the conductive resin layer may include a metal oxide filler such as aluminum oxide. However, from the viewpoint of the fluidity of the resin due to heat generation at the time of internal short-circuit, the content of the metal oxide filler in the conductive resin layer is less than 10% by mass, less than 5% by mass, less than 1% by mass, or 0. It is preferably less than 1% by mass. It is more preferable that the content of the metal oxide filler in the conductive resin layer does not include a metal oxide filler.

### Method for Producing Current Collector

The method of manufacturing the current collector of the present disclosure is not particularly limited, and an existing resin thin film deposition technique can be appropriately employed.

For example, the current collector 10 can be manufactured by kneading a resin 12a and a conductive material 12b and rolling them on the metal foil 11. In addition, the current collector 10 can be manufactured by coating a slurry including a resin 12a and a conductive material 12b on the metal foil 11 and then drying the slurry.

### Secondary Battery

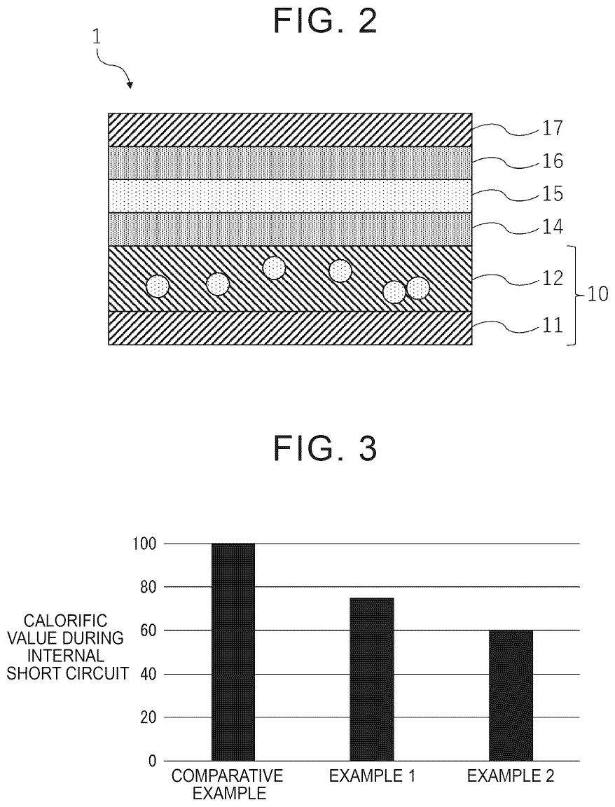

The secondary battery of the present disclosure includes a cathode current collector and a anode current collector, and at least one of the cathode current collector and the anode current collector is the current collector of the present disclosure. FIG. 2 is a schematic cross-sectional view showing a secondary battery 1 of the present disclosure using a current collector 10 of the present disclosure as a cathode current collector. In this case, the metal foil 11 and the conductive resin layer 12 as the cathode current collector 10, and the cathode active material layer 14, the electrolyte layer 15, the anode active material layer 16, and the anode current collector 17 may be provided in this order.

The secondary battery of the present disclosure may be a liquid-based battery or a solid-state battery. In the context of the present disclosure, a “solid battery” means a battery using at least a solid electrolyte as an electrolyte, and therefore a solid battery may use a combination of a solid electrolyte and a liquid electrolyte as an electrolyte. The solid-state battery of the present disclosure may be an all-solid-state battery, that is, a battery using only a solid electrolyte as an electrolyte.

### Cathode Current Collector and Anode Current Collector

For the current collector, reference can be made to the above description of the current collector of the present disclosure.

### Cathode Active Material Layer and Anode Active Material Layer

The cathode active material layer contains a cathode active material, and optionally a solid electrolyte, a conductive auxiliary agent, and a binder. The anode active material layer contains a anode active material, and optionally a solid electrolyte, a conductive auxiliary agent, and a binder.

### Cathode Active Material

As the cathode active material, a known active material may be used. For example, in the case of forming a lithium ion battery, various lithium-containing composite oxides can be used as the cathode active material. The various lithium-containing complex oxides are lithium cobaltate, lithium nickelate, LiNi_{1/3}Co_{1/3}Mn_{1/3}O₂, lithium manganate, spinel-based lithium compounds, and the like. In addition, lithium-iron phosphate (LFP) can be used as the olivine-type cathode active material. The cathode active material may be, for example, in a particulate form, and the size thereof is not particularly limited.

The cathode active material may have a coating layer. For example, in the case of configuring a lithium ion battery, the coating layer is a layer containing a material that has lithium ion conductivity, has low reactivity with a cathode active material or a solid electrolyte, and is capable of maintaining the form of a coating layer that does not flow even when in contact with an active material or a solid electrolyte. Specific examples of the material configuring the coating layer may be, in addition to LiNbO₃, Li₄Ti₅O₁₂, Li₃PO₄, but are not limited thereto.

### Anode Active Material

A known active material may be used as the anode active material. For example, when a lithium-ion battery is configured, a Si anode active material; a carbon-based anode active material; various oxide-based anode active materials; metallic lithium, a lithium alloy, or the like can be used as the anode active material. Examples of the Si anode active material include silicon (Si), a Si alloy, and silicon oxide. Examples of the carbon-based anode active material include graphite and hard carbon. The various oxide-based anode active materials are, for example, lithium titanate. The anode active material may be, for example, in a particulate form, and the size thereof is not particularly limited.

In particular, the anode active material may be a Si anode active material. Si is more likely to generate heat at a low temperature (about 160 to 220° C.) than the carbon-based anode active material. Therefore, in a secondary battery using Si as the anode active material, when the temperature of the battery rises due to an internal short circuit or the like, there is a possibility that heat generation of Si occurs, and it is difficult to suppress an increase in the heat generation value of the battery. On the other hand, when the current collector of the secondary battery is the current collector of the present disclosure, even if the anode active material is a Si anode active material, heat generation at the time of an internal short circuit can be effectively suppressed.

### Solid Electrolyte, Conductive Auxiliary Agent, and Binder

The material of the solid electrolyte is not particularly limited, and a material that can be used as a solid electrolyte used in a secondary battery can be used. For example, the solid electrolyte may be a sulfide solid electrolyte.

Examples of sulfide solid electrolytes include, but are not limited to, sulfide amorphous solid electrolytes, sulfide crystalline solid electrolytes, or argyrodite solid electrolytes. Specific examples of the sulfide solid electrolytes include Li₂S—P₂S₅ system, Li₂S—SiS₂, LiI—Li₂S—SiS₂, LiI—Li₂S—P₂S₅, LiI—LiBr—Li₂S—P₂S₅, Li₂S—P₂S₅—GeS₂, LiI—Li₂S—P₂O₅, LiI—Li₃PO₄—P₂S₅, Li₇₋ₓPS₆₋ₓClₓ, and the like, or combinations thereof. However, the specific sulfide solid electrolyte is not limited thereto. The Li₂S—P₂S₅ system is, for example, Li₇P₃S₁₁, Li₃PS₄, Li₈P₂S₉, and the like. Li₂S—P₂S₅—GeS₂ is, for example, Li₁₃GeP₃S₁₆, Li₁₀GeP₂S₁₂, etc. The sulfide solid electrolyte may be glass or crystallized glass (glass ceramic).

The conductive aid is not particularly limited. For example, the conductive aid may be vapor grown carbon fiber (VGCF) and acetylene black (AB), Ketjen black (KB), carbon nanotubes (CNT), carbon nanofibers (CNF), etc. However, the conductive auxiliary agent is not limited thereto.

The binder is not particularly limited. For example, the binder may be a material such as, but not limited to, polyvinylidene fluoride (PVdF), butadiene rubber (BR), or styrene butadiene rubber (SBR), or a combination thereof.

### Electrolyte Layer

The electrolyte layer may be a solid electrolyte layer comprising at least a solid electrolyte. The solid electrolyte layer may optionally include a binder or the like. For the solid electrolyte and the binder, reference can be made to the above description of the cathode active material layer and the anode active material layer of the present disclosure.

The method of manufacturing the secondary battery of the present disclosure is not particularly limited, and can be manufactured by applying a conventionally known method.

### Comparative Production Example

### Preparation of Current Collector

Polyvinylidene fluoride (PVdF) (melting point: 150° C.) 60% by mass, aluminum oxide (Al₂O₃) 30% by mass, acetylene black (AB) 10% by mass, and solvent-containing slurry as a conductive material were applied to an aluminum (Al) foil with a Gap 50 coating blade. This was dried to prepare a current collector of the comparative production example.

### Production Example 1

A slurry comprising 80% by weight of a vinyl chloride-based resin (melting point: 85° C.), a vapor grown carbon fiber (VGCF) 20% by mass) as a conductive material, and a solvent was applied to Al foil by a Gap 50 coating blade. This was dried to prepare a current collector of Production Example 1. The thickness of the formed conductive resin layer was 5 μm.

### Production Example 2

A current collector of Production Example 2 was produced in the same manner as in Production Example 1 except that the resin was an acrylic resin (melting point: 60° C.). The thickness of the formed conductive resin layer was 5 μm.

### Comparative Example

### Preparation of Solid-State Battery

### Preparation of Cathode Current Collector

As the cathode current collector, the current collector of the comparative production example was used.

### Forming of Cathode Active Material Layer

A cathode active material layer (thickness: 70 μm) was obtained by weighing and molding a cathode active material, a sulfide solid electrolyte, a conductive auxiliary agent, and a binder so as to have a mass ratio of cathode active material:sulfide solid electrolyte:conductive auxiliary agent:binder=85:13:1.3:0.7. As the cathode active material, LiNi_{0.8}Co_{0.15}Al_{0.05}O₂ (manufactured by Sumitomo Metal Mining Co., Ltd.) coated with LiNbO₃ was used. As the sulfide solid-electrolyte, 10LiI-90 (0.75Li₂S-0.25P₂S₅) was synthesized, crystallized, and atomized. As the conductive auxiliary agent, a vapor-phase carbon fiber (VGCF, manufactured by Showa Denko Co., Ltd.) was used. PVdF was used as the binder.

### Forming of Solid Electrolyte Layer

A sulfide solid electrolyte and a binder similar to those described above were mixed at a mass ratio of 99.6:0.4 to form a solid electrolyte mixture, and the obtained solid electrolyte mixture was molded to obtain a solid electrolyte layer (thickness: 15 μm).

### Molding of Anode Active Material Layer

A anode active material layer (thickness: 50 μm) was obtained by weighing and molding a anode active material, a sulfide solid electrolyte, a conductive auxiliary agent, and a binder so as to have a mass ratio of anode active material:sulfide solid electrolyte:conductive auxiliary agent:binder=53:41:4.5:1.5. As the anode active material, Si (manufactured by Mitsui Metals Co., Ltd., mean grain size D50=2.5 μm) was used. The sulfide solid electrolyte, the conductive auxiliary agent, and the binder are the same as those used in the cathode active material layer.

### Preparation of Anode Current Collector

A nickel (Ni) foil (30 μm thick) was used as the anode current collector.

### Preparation of Solid-State Battery

Each of the above layers was used to obtain a solid battery having a layer structure of a “cathode current collector (metal foil/conductive resin layer)/cathode active material layer/solid electrolyte layer/anode active material layer/anode current collector”. The conductive resin layer of the current collector was laminated so as to be in contact with the cathode active material layer. The obtained solid-state batteries were subjected to initial-capacity check (2.5-4.05 V (CCCV), charge ⅓ C, discharge ⅓ C, and 1/100 C of resting conditions, five cycles). Then, the solid-state battery of the comparative example was obtained by performing voltage regulation (4.05 V, CCCV, charge ⅓ C, and 1/100 C of resting conditions) on the individual battery.

### Examples 1 and 2

Solid-state batteries of Examples 1 and 2 were obtained in the same manner as in Comparative Example except that the current collector of Production Example 1 or 2 was used instead of the current collector of Comparative Production Example in the preparation step of the cathode current collector. The numbers of the manufacturing examples correspond to the numbers of the embodiments.

### Evaluation

### Evaluation of Calorific Value of Battery

A nail penetration test was carried out in which a central part of a solid-state cell was penetrated at a rate of 1 μm/s with a nail having a diameter 3 mm and a tip angle of 45°. For each of the solid-state batteries according to Examples and Comparative Examples, the behavior of the current and the voltage at the time of the nail penetration test was observed, and the resistance of the battery was calculated from the amount of change from the initial value of the current and the voltage at the time when the internal short circuit occurred. Further, the calorific value of the battery was calculated based on the following formula:

$$Heating value [ W ] = {Current [ A ]}^{2} \times Resistance [ Ω ] .$$

### Results

FIG. 3 shows the results. The results of the examples are shown as relative values where the results of the comparative examples are set to 100. As shown in FIG. 3, compared to the solid battery according to the comparative example, the solid battery according to the example had a small amount of heat generation at the time of internal short-circuit. In particular, in Example 2 in which an acrylic resin having a lower melting point was used, the calorific value at the time of internal short-circuit was the smallest.

What is claimed is:

1. A current collector, comprising: a metal foil; and
a conductive resin layer laminated on the metal foil, wherein
the conductive resin layer includes a resin and a conductive material, and
a melting point of the resin is lower than 120° C.

2. The current collector according to claim 1, wherein a content of the resin in the conductive resin layer is no less than 50% by mass.

3. The current collector according to claim 1, wherein a thickness of the conductive resin layer is no less than 1 μm and no more than 10 μm.

4. A secondary battery, comprising:
a cathode current collector; and an anode current collector, wherein at least one of the cathode current collector and the anode current collector is the current collector according to claim 1.

5. The secondary battery according to claim 4, further comprising:
an anode active material layer, wherein the anode active material layer includes a silicon-based anode active material.
